(19) United States
(12) Patent Application Publication
(10) Pub. No.: US 2003/0221308 A1
(43) Pub. Date: Dec. 4, 2003

(54) Machining apparatus with pivotal workpiece holder

(75) Inventor: Norbert Hessbruggen, Salach (DE)

Correspondence Address: THE FIRM OF KARL F ROSS, 5676 RIVERDALE AVENUE, PO BOX 900, RIVERDALE (BRONX), NY, 10471-0900, US

(73) Assignee: EMAG Maschinenfabrik GmbH

(21) Appl. No.: 10/438,112

(22) Filed: May 14, 2003

(30) Foreign Application Priority Data
May 29, 2002 (DE) 10224347.6

(51) Int. Cl. B23Q 7/00

(52) U.S. Cl. 29/563

(57) ABSTRACT

A machining apparatus has a housing defining a supply station and a machining station, a holder slide, and an actuator for displacing the holder slide on the workpiece in a main direction between the stations. A tool at the machining station can machine a workpiece. A pair of bearings spaced apart on the holder slide and defining an axis hold a shaft of a holder mounted on the holder slide between the bearings and having a shaft seated in both of the bearings for pivoting about the axis. The holder is adapted to carry a workpiece.

### FIELD OF THE INVENTION

The present invention relates to a machining apparatus. More particularly this invention concerns such an apparatus for drilling, milling, lathing, or grinding a workpiece.

### BACKGROUND OF THE INVENTION

A standard machining apparatus as described in German 199 04 860 of G. Rehage and U.S. Pat. No. 5,439,431 of N. Hessbruggen has a workpiece holder from which a stub shaft projects in one direction. A bearing on the machine frame holds this shaft and a drive allows the holder and a workpiece carried by it to be pivoted about the axis of the shaft. The bearing in turn is typically movable horizontally and vertically, in the so-called X- and Z-directions. This makes it possible for the holder to pick an unmachined workpiece up out of a supply station adjacent the machining station, move it to the machining station, position it as required relative to the tools in the machining station, and then move it back to the supply station or to an outfeed station and deposit it there.

Such a system is relatively effective, but often the workpiece positioning lacks the high degree of accuracy that some jobs require.

### OBJECTS OF THE INVENTION

It is therefore an object of the present invention to provide an improved machining apparatus.

Another object is the provision of such an improved machining apparatus which overcomes the above-given disadvantages, that is which is extremely stiff so as to be able to position the workpiece with great accuracy.

### SUMMARY OF THE INVENTION

A machining apparatus has according to the invention a housing defining a supply station and a machining station, a holder slide, and an actuator for displacing the holder slide on the workpiece in a main direction between the stations. A tool at the machining station can machine a workpiece. A pair of bearings spaced apart on the holder slide and defining an axis hold a shaft of a holder mounted on the holder slide between the bearings and having a shaft seated in both of the bearings for pivoting about the axis. The holder is adapted to carry a workpiece between the stations and hold it in the machining station.

Pivoting the workpiece holder on two sides, preferably located near the actual chuck holding the workpiece, ensures very accurate positioning of the workpiece. The axis is perpendicular to the principal displacement direction(s) of the holder slide.

According to the invention the housing slide is fork-shaped and has a pair of arms in which the bearings are fixed. Unlike a standard system where a shaft is journaled in two axially offset bearings, here both of the bearings are of the “fixed” type, that is their outer and inner races cannot shift axially relative to each other. Since the shaft ends seated in the bearings are fixed relative to each other on the workpiece holder, this imparts considerable stiffness to the system. The arms are unitarily formed with the holder slide and each other, normally of heavy cast metal to form an extremely solid mount for the workpiece holder embraced between the arms.

A drive is provided in accordance with the invention in the holder slide for pivoting the workpiece holder about the axis and a brake in the holder slide can fix the workpiece angularly relative to the axis.

In addition according to the invention a turret holds a plurality of tools in the housing and a drive motor in the housing and a tool rotatable by the drive motor in the machining station can pick tools out of a magazine and use them on the workpiece held in the machining station. Alternately the chuck holder can simply press the workpiece against a stationary tool held in the turret.

The holder slide in accordance with the invention can also be displaced in another direction perpendicular to the main direction. A controller and sensor are provided on the housing for monitoring the workpiece and controlling its dimensions.

### BRIEF DESCRIPTION OF THE DRAWING

The above and other objects, features, and advantages will become more readily apparent from the following description, reference being made to the accompanying drawing in which:

FIG. 1 is a vertical section through the apparatus according to the invention; and

FIG. 2 is a section taken along line II-II of FIG. 1.

### SPECIFIC DESCRIPTION

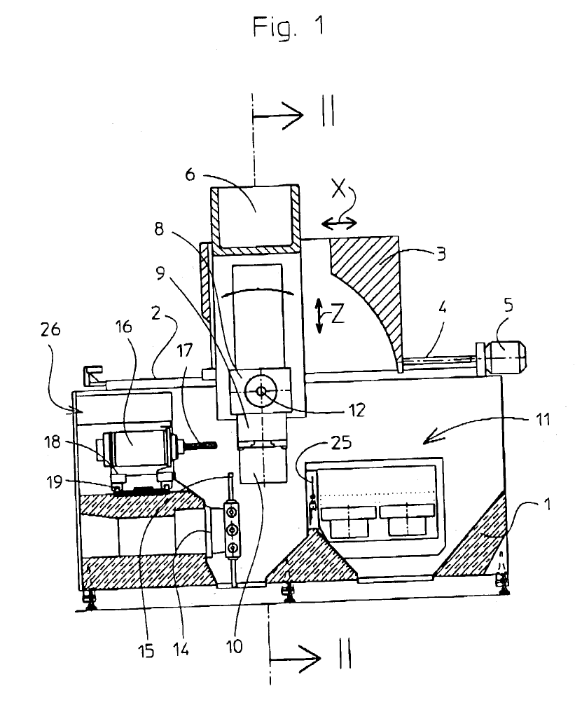

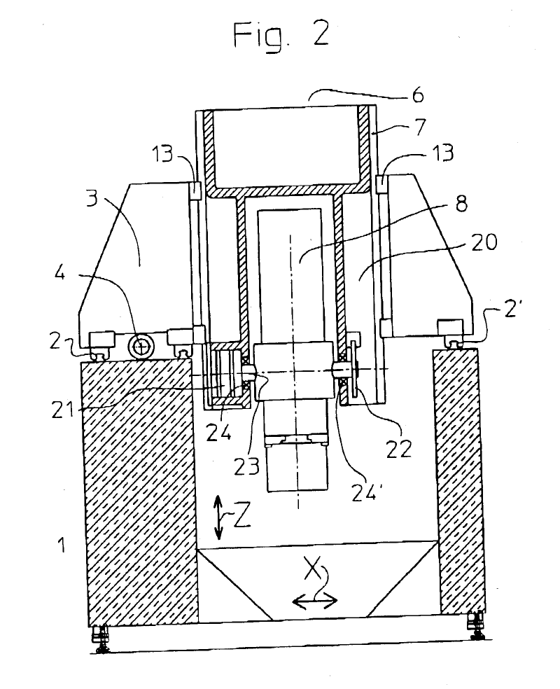

As seen in FIGS. 1 and 2, a machining apparatus according to the invention has a normally stationary frame or housing 1 on which a main slide 3 is supported by rails 2 for displacement in a horizontal side-to-side direction X by means of a motor 5 and ball-roller spindle 4. This slide 3 is in turn provided as best shown in FIG. 2 with guides 13 engaging rails 7 of a secondary or holder slide 6 displaceable vertically in a direction Z. Another drive like the motor 5 is provided for such vertical displacement. This slide 3 is fork-shaped and has a pair of downwardly depending arms 20 carrying bearings 24 which define a horizontal axis 12 extending in a front-to-back horizontal direction Y and in which are journaled stub shafts 23 of a pivotal workpiece holder 8 carrying a chuck 9 adapted to hold a workpiece 10. A drive motor 21 in the holder slide 6 can rotate the support 8 about the axis 12 and a brake 22 can arrest it in any angular position. The fork-shaped holder slide 20 is a massive cast piece so that the two bearings 24 are solidly fixed relative to each other. In addition the bearings are of the fixed type, so that the stub shafts 23 cannot shift axially in the arms 20.

The frame 1 has on one side a supply/outfeed station 11 coupled with an unillustrated conveyor for bringing unmachined workpieces 10 into the machine and taking away machined workpieces. On the other side of the frame 1 is a machining station 26 here comprising a pivotal turret 14 carrying a plurality of tools 15. This can include millers, countersinking drilling or threading bits, lathe cutters, grinding stones, and the like. Thereabove, a drive 16 can rotate a tool 17, here a drill bit, about an axis parallel to the direction X and has a base 18 movable along tracks 19 in the direction Y. A sensor 25 is provided as part of a controller that monitors operation of the supply station 11, controls movement of the chuck 9 to and from it, and operation of the machining drive 16 and its actuator on the rails 19 so as to monitor and control the dimensions of the workpiece 10.

In a normal machining cycle the actuator 5 moves the slide 3 over to the station 10 so the chuck 9 can be dropped down by the slide 6 to pick up a workpiece 10. Then the slide 6 is raised and the drive 5 moves the slide 3 to the other side to align the picked-up workpiece 10 with the tool 15 held by the turret 14 or 17 held by the machining drive 16. The desired machining is performed, and then the chuck 9 is moved to the side and down to drop the finished workpiece 10 off in the station 11. The cycle can then repeat.

With this system the workpieces 10 can be positioned with great accuracy. It is possible to set them at virtually any desired orientation relative to the tool 17 held in the drive 16, and even, if desired, to rotate the workpiece 10 about a center axis of the holder 8. The rigidity of the holder slide 6 is such that the workpiece 10, once set in a desired position, will not be shifted by normally machining forces so that it can be drilled, milled, lathed, or ground.

I claim:

1. A machining apparatus comprising:
a housing defining a supply station and a machining station;
a holder slide;
actuating means for displacing the holder slide on the workpiece in a main direction between the stations;
means at the machining station for machining a workpiece;
a pair of bearings spaced apart on the holder slide and defining an axis; and
a holder mounted on the holder slide between the bearings and having a shaft seated in both of the bearings for pivoting of the holder on the holder slide about the axis, the holder being adapted to carry a workpiece between the stations and hold it in the machining station.

2. The machining apparatus defined in claim 1 wherein the housing slide is fork-shaped.

3. The machining apparatus defined in claim 2 wherein the slide has a pair of arms and the bearings are of the fixed type.

4. The machining apparatus defined in claim 2, further comprising
drive means in the holder slide for pivoting the workpiece holder about the axis.

5. The machining apparatus defined in claim 4, further comprising
brake means in the holder slide for fixing the workpiece angularly relative to the axis.

6. The machining apparatus defined in claim 1, further comprising
a turret holding a plurality of tools in the housing.

7. The machining apparatus defined in claim 1 wherein the machining means includes
a drive motor and
a tool rotatable by the drive motor in the machining station.

8. The machining apparatus defined in claim 1 wherein the actuating means can also displace the holder slide in another direction perpendicular to the main direction.

9. The machining apparatus defined in claim 1, further comprising
sensor means on the housing for monitoring the workpiece.
